(19) United States
(12) Patent Application Publication
(10) Pub. No.: US 2010/0314080 A1
(43) Pub. Date: Dec. 16, 2010

(54) HEAT DISSIPATION DEVICE

(75) Inventors: LEI CAO, Shenzhen City (CN); MIN LI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Taipei Hsien (TW)

(21) Appl. No.: 12/566,692

(22) Filed: Sep. 25, 2009

(30) Foreign Application Priority Data
Jun. 15, 2009 (CN) 200910303243.1

(51) Int. Cl. G06F 1/20; F28D 21/00; F28F 7/00

(52) U.S. Cl. 165/121; 165/185

(57) ABSTRACT

A heat dissipation device includes a heat conducting board for being attached to an electronic component mounted on a printed circuit board, a fin unit disposed on the heat conducting board, a fixing module and a fan secured on the fixing module. The fixing module includes two supporting frames located at two opposite lateral sides of the fin unit respectively, a fan holder spanning over the fin unit and pivotally fixed to the two supporting frames, and a fastening member extending through the fan holder and a corresponding supporting frame and being capable of fixing the fan holder at different positions relative to the fin unit of the heat sink. The fan is fixed to the fan holder of the fixing module and provides airflow towards the fin unit.

### BACKGROUND

1. Technical Field

The disclosure generally relates to heat dissipation devices and, more particularly, to a heat dissipation device incorporating a fan.

2. Description of Related Art

With the fast development of electronic industry, advanced electronic components such as CPUs (central processing units), or GPUs (graphics processing units) are being made with ever faster operating speeds. Greater emphasis is now being laid on increasing the efficiency and effectiveness of heat dissipation devices so as to keep operational temperature of the electronic components within a suitable range. Generally, in order to ensure a temperature of a heat-generating electronic component within a safe threshold level, a heat dissipation device is provided which comprises a heat sink, and a fan and heat pipes combined to the heat sink. The fan is fixed to the heat sink at a predetermined position of a top or a lateral side of the heat sink by a fan holder.

However, the fan of the heat dissipation device can only produce airflow in a determined direction towards the heat sink. In a computer, there are some other electronic components located adjacent to the electronic component. After the airflow passes through the heat sink, it is required that the airflow can also flow through the other electronic components to help heat dissipation thereof. However, since the fan is permanently fixed to the heat sink and cannot be easily redirected/relocated, it is difficult to adapt the heat dissipation device to computers of different models/configurations, in which an airflow generated by a fan of the heat dissipation device can cool not only the main electronic component but also the other electronic components around the main electronic component.

What is needed, therefore, is a heat dissipation device incorporating a fan which can overcome the limitations described above.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an assembled, isometric view of a heat dissipation device in accordance with an embodiment of the disclosure.

FIG. 2 is an exploded view of the heat dissipation device of FIG. 1, with a printed circuit board having an electronic component mounted thereon.

FIG. 3 is an exploded view of a fixing module of the heat dissipation device of FIG. 1.

FIG. 4 is another assembled, isometric view of the heat dissipation device of FIG. 1, with a fan of the heat dissipation device is rotated to another position of the heat dissipation device.

### DETAILED DESCRIPTION

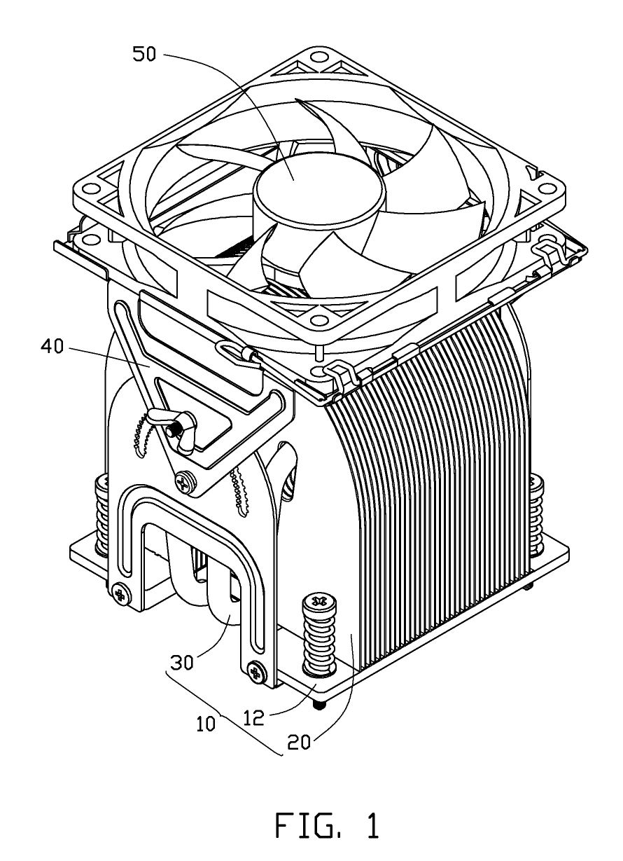

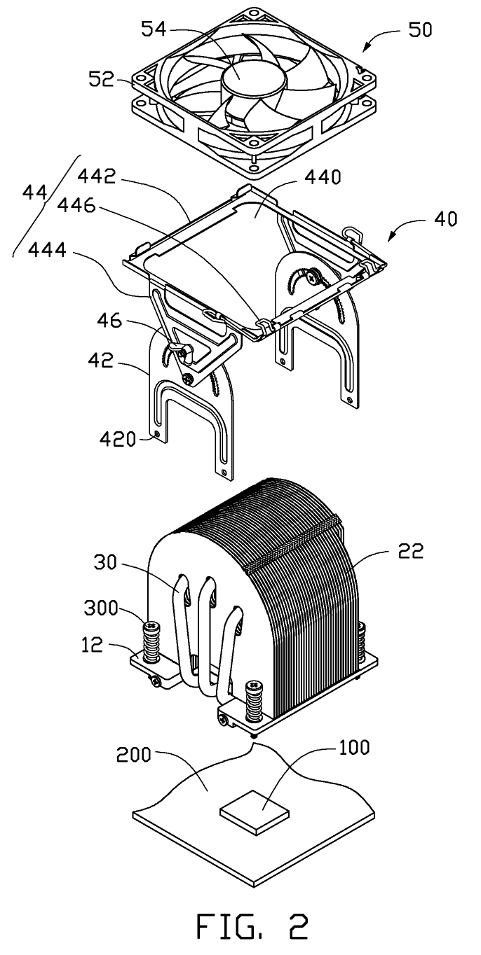

Referring to FIGS. 1-2, a heat dissipation device in accordance with an embodiment of the disclosure dissipates heat from an electronic component 100 such as a CPU (central processing unit), which is mounted on a printed circuit board 200. The heat dissipation device comprises a heat sink 10 fixed to the printed circuit board 200 and thermally in contact with the electronic component 100, a fixing module 40 disposed on the heat sink 10, and a fan 50 secured on the fixing module 40 and located over/beside the heat sink 10 via the fixing module 40, whereby airflow produced by the fan 50 flows towards the heat sink 10.

The heat sink 10 comprises a heat conducting board 12 attached to the electronic component 100, a fin unit 20 disposed on the heat conducting board 12 and a plurality of heat pipes 30 thermally connecting the heat conducting board 12 and the fin unit 20.

The heat conducting board 12 is integrally formed of a metallic material with a good thermal conductivity, such as copper, aluminum or an alloy thereof. A bottom face of the heat conducting board 12 is attached to the electronic component 100. Four fasteners 300 extend through the heat conducting board 12 and engage with the printed circuit board 200 for securing the heat dissipation device on the printed circuit board 200, whereby the heat conducting board 12 can have an intimate contact with the electronic component 100.

The fin unit 20 comprises a plurality of fins 22 parallel to and spaced from each other. The fins 22 are made of metallic sheets and each have a configuration of an arched door. The fins 22 are perpendicularly soldered on the heat conducting board 12. The fins 22 are parallel to two opposite lateral sides, i.e., left and right lateral sides, of the heat conducting board 12. A top edge of each fin 22 has a semicircular profile. A plurality of air passages are defined between every two neighboring fins 22 for airflow from the fan 50 flowing therethrough to bring heat generated by the electronic component 100 into ambient environment. Three elongated receiving grooves (not labeled) are defined in the fin unit 20 for accommodating the heat pipes 30, respectively. The receiving grooves transversely extend through the fin unit 20 and are perpendicular to the fins 22.

Each heat pipe 30 is U-shaped and comprises a horizontal evaporation section (not labeled), a vertical adiabatic section (not labeled) extending upwardly from a lateral end of the evaporation section and a condensation section (not labeled) extending horizontally from a top end of the adiabatic section and parallel to the evaporation section. The evaporation sections of the heat pipes 30 are juxtaposed to each other and embedded in the bottom face of the heat conducting board 12. The evaporation sections have bottom faces coplanar with the bottom face of the heat conducting board 12 and contacting with the electronic component 100. The condensation sections of the heat pipes 30 spaced from each other are perpendicularly extended through the fin unit 20 and securely received in the receiving grooves defined in the fin unit 20 by soldering.

The fan 50 comprises a square frame 52 with a size corresponding to that of the fixing module 40 and an impeller 54 rotatably received in the frame 52.

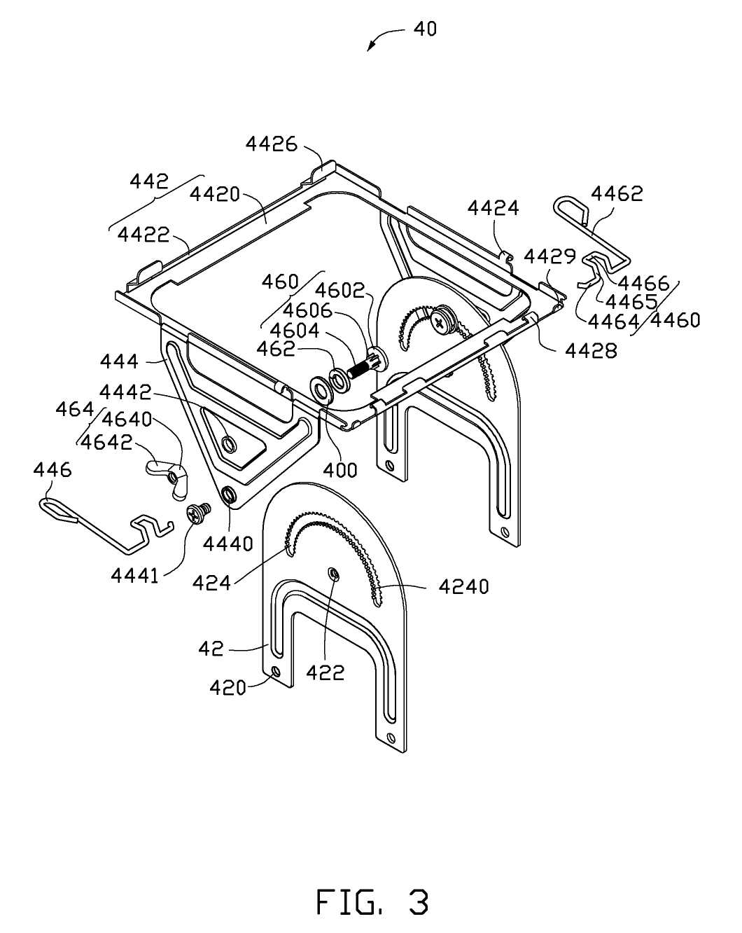

Referring to FIG. 3 also, the fixing module 40 comprises two supporting frames 42 fixed to two lateral sides of the heat sink 10 respectively, a fan holder 44 spanning over the fin unit 20 and pivotally connected to the two supporting frames 42 and two fastening members 46 positioning the fan holder 44 relative to the two supporting frames 42. In general, the fixing module 40 is bilaterally symmetrical relative to the fin unit 20.

Each supporting frame 42 is an upright sheet and has a profile similar to the fin 22, whereby a top edge of the supporting frame 42 also has a semicircular profile. The two supporting frames 42 are parallel to the fins 22 and perpendicular to the heat conducting board 12. The two supporting frames 42 are fixed to the left and right lateral sides of the heat conducting board 12, respectively. A rectangular cut (not labeled) is defined at a center of a bottom of each supporting frame 42. Two mounting holes 420 are defined at two bottom corners of each supporting frame 42, for two screws (not labeled) extending therethrough and screwing into the heat conducting board 12, respectively. A fixing hole 422 is defined at the top portion of each supporting frame 42, and the fixing hole 422 is just positioned at a center of a circle defining the semicircular top edge of the supporting frame 42. A semicircular guiding groove 424 is defined at the top portion of the supporting frame 42. A center of a circle defining the guiding groove 424 is coincident with that of the top edge of the supporting frame 42, both of which are located at the fixing hole 422. The supporting frame 42 defines a plurality of sawteeth 4240 protruding from two long sides of the guiding groove 424 towards each other.

The fan holder 44 comprises a holding frame 442 holding the fan 50, two pivoting portions 444 pivotally connecting to the two supporting frames 42 respectively and two fastening wires 446 securing the fan 50 to the holding frame 442. The holding frame 442 is square and has a size slightly larger than a size of the bottom face of the fan 50 to fitly accommodate a lower portion of the fan 50 thereon. An opening 440 is defined in a center of the holding frame 442 for providing an air access from the fan 50 to the heat sink 10. In detail, the holding frame 442 comprises four beams 4420 at a periphery of the opening 440 and four flanges 4422 extending upwardly from outer edges of the four beams 4420 respectively to form a substantially square space to accommodate the lower portion of the fan 50 therein. Two spaced elastic flakes 4426 extend upwardly and inwardly from one flange 4422 to engage with one side of the frame 52 of the fan 50 to lock the one side of the fan 50 onto the holding frame 442. Two arced restricting tabs 4428 extend from an opposite flange 4422 toward the two elastic flakes 4426 to thereby defining a receiving space (not labeled) between the tabs 4428 and the holding frame 442 to pivotally receive the fastening wires 446 therein. The two restricting tabs 4428 are separated from each other and located nearby two ends of the flange 4422 respectively. Two baffle tabs 4429 protrude upwardly from the flange 4422 and located adjacent to the two restricting tabs 4428, respectively. The baffle tabs 4429 are provided for cooperating with the two restricting tabs 4428 to position the fastening wires 446 in place. Two locking ears 4424 extend upwardly from the other two opposite beams 4420 and are curved outwardly and oppositely away from each other. Each locking ear 4424 has a C-shaped configuration. The two locking ears 4424 are located adjacent to the two restricting tabs 4428, respectively.

The two pivoting portions 444 extend downwardly and perpendicularly from two opposite lateral sides, i.e., the left and right lateral sides, of the holding frame 442. Each of the pivoting portions 444 has a shape of an isosceles triangle, with an apex thereof located distant from and below the corresponding holding frame 442. A pivoting hole 4440 is defined at a bottom end of each pivoting portion 444, near the apex. A pivoting screw 4441 is further provided to the pivoting portion 444 for acting as a pivotal axis. The pivoting screw 4441 extends through the pivoting hole 4440 and then screws into the fixing hole 422 of the supporting frame 42. A diameter of the pivoting screw 4441 is less than that of the pivoting hole 4440, thereby allowing the pivoting portion 444 to pivot relative to the pivoting screw 4441. A through hole 4442 is defined at a center of each of the pivoting portions 444. A distance between the pivoting hole 4440 and the through hole 4442 of the pivoting portion 444 is equal to that between the fixing hole 422 and the guiding groove 424 of the supporting frame 42, whereby when the pivoting portion 444 is assembled to the supporting frame 42, the pivoting hole 4440 communicates with the fixing hole 422 and the through hole 4442 communicates with the guiding groove 424.

Each fastening wire 446 is formed by bending an elastic metallic wire and has a substantially L-shaped configuration. Each fastening wire 446 comprises a pivot shaft 4460 and a handle 4462 extending perpendicularly from one end of the pivot shaft 4460.

The pivot shaft 4460 comprises two separated pivoting sections 4464 substantially in line with each other to define a pivoting axis, two connecting sections 4465 extending perpendicularly from two respective adjacent ends of the pivoting sections 4464 and a U-shaped pressing section 4466 formed at top ends of the two connecting sections 4465. The U-shaped pressing section 4466 is at an obtuse angle to the connecting sections 4465, and has a middle portion offsetting from the pivoting sections 4464. The handle 4462 is angled to the holding frame 442 and the connecting sections 4465 when the pivoting sections 4464 of the fastening wire 446 are pivotally positioned between the tabs 452 and the holding frame 442 (clearly seen in FIG. 1). A free end of the handle 4462 is folded back for facilitating an operation of the fastening wire 446.

Each fastening member 46 comprises a screw member 460, an elastic member 462 positioned around the screw member 460 and an engaging nut, for example, a wing nut 464 for threadedly engaging with the screw member 460. The screw member 460 comprises a flat columnar head 4602, a post 4604 extending outwardly and perpendicularly from a bottom of the head 4602 and a plurality of spaced baffle ribs 4606 protruding outwardly from a periphery of the post 4604 and near the bottom of the head 4602. A periphery of a distal end of the post 4604 defines plural threads for engaging with the wing nut 464. The baffle ribs 4606 connect with the bottom of the head 4602 and extend along an axis of the post 4604. The wing nut 464 comprises a cylindrical main body 4640 and two arms 4642 extending outwardly and inclinedly from a periphery of the main body 4640 for facilitating an operation of the wing nut 464. The main body 4640 of the wing nut 464 threadedly engages on the post 4604, whereby the wing nut 464 can move linearly from the distal end of the post 4604 towards the head 4602, along the axis of the post 4604, when the wing nut 464 is rotated on the post 4604. The post 4604 of the screw member 460 extends through the guiding groove 424 of the supporting frame 42, and then through the through hole 4442 of the pivoting portion 444. The supporting frame 42 and the pivoting portion 444 are sandwiched between the head 4602 of the screw member 460 and the wing nut 464. Two opposite baffle ribs 4606 of the screw member 460 each are stuck between two adjacent sawteeth 4240 of the supporting frame 42. The elastic member 462 is compressed between the head 4602 of the screw member 460 and the supporting frame 42. An annular gasket 400 is further provided to the fastening member 46; the gasket 400 is sandwiched between the elastic member 462 and the supporting frame 42.

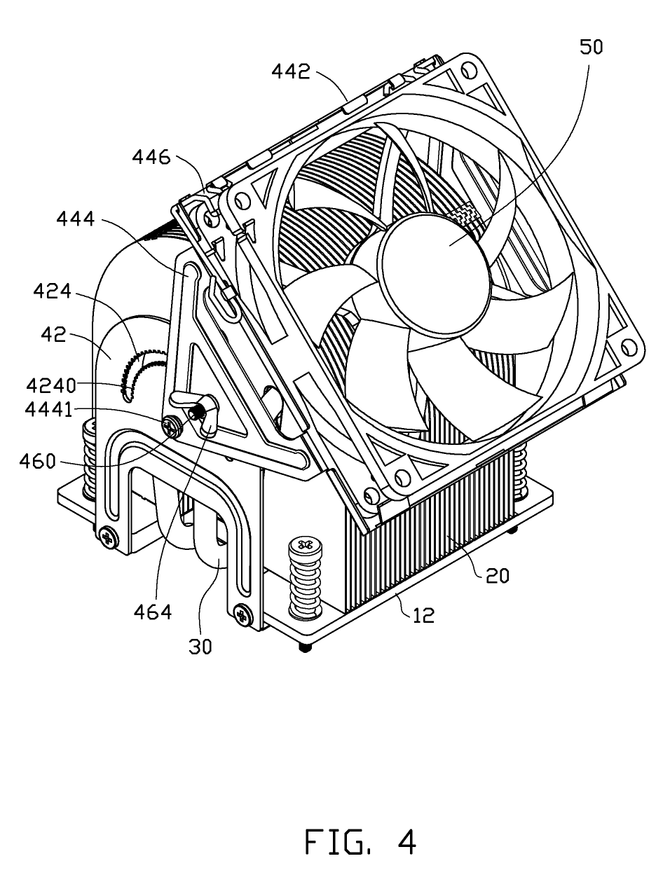

Referring to FIGS. 1 through 4, in assembly of the heat dissipation device, the fastening wires 446 are pivotally assembled to the holding frame 442 and secure the fan 50 to the fan holder 44. The two supporting frames 42 are fixed to the heat conducting board 12, in which each fastening member 46 extends through and locks a corresponding pivoting portion 444 of the fan holder 44 and supporting frame 42 together.

In operation, when the fastening member 46 is in a locked state, the two baffle ribs 4606 of the fastening member 46 each is stuck between two neighboring sawteeth 4240 of the supporting frame 42, whereby the fan holder 44 with the fan 50 is positioned at an original position relative to the fin unit 20. To change the position the fan 50 located relative to the fin unit 20, the wing nut 464 is rotated with respect to the axis of the post 4604 of the screw member 460 to move away from the head 4602 of the screw member 460; then, a distance between the head 4602 and the wing nut 464 gradually increases; the elastic member 462 pushes the head 4602 to move away from the supporting frame 42. When a distance between the wing nut 464 and distal ends of the baffle ribs 4406 is long enough to make the baffle ribs 4606 separate from the sawteeth 4240, the fan holder 44 with the fan 50 can pivot relative to the pivoting screw 4441 along the outer circumference of the fin unit 20. When the fan holder 44 is in the pivoting state, the fastening member 46 together with the pivoting portion 444 of the fan holder 44 moves along the guiding groove 424 of the supporting frame 42. When the fan holder 44 with the fan 50 is pivoted to a required position, the wing nut 464 is rotated with respect to the axis of the post 4604 of the screw member 460 in an opposite direction towards the head 4602 of the screw member 460, until two opposite baffle ribs 4606 are stuck between neighboring sawteeth 4240 of the supporting frame 42, thereby completing reposition of the fan holder 44 and the fan 50 relative to the fin unit 20 of the heat sink 10.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A heat dissipation device adapted for dissipating heat from an electronic component mounted on a printed circuit board, the heat dissipation device comprising:
a heat sink comprising a heat conducting board for being attached to the electronic component and a fin unit disposed on the heat conducting board;
a fixing module comprising two supporting frames located at two opposite lateral sides of the fin unit respectively, a fan holder spanning over the fin unit and pivotally fixed to the two supporting frames, and a fastening member extending through the fan holder and a corresponding supporting frame, the fastening member being capable of fixing the fan holder at different positions relative to the fin unit of the heat sink; and
a fan fixed to the fan holder of the fixing module.

2. The heat dissipation device as claimed in claim 1, wherein the two supporting frames are fixed to the heat conducting board.

3. The heat dissipation device as claimed in claim 1, wherein the fin unit consists of a plurality of fins upright arranged on the heat conducting board, and the fins are parallel to and spaced from each other.

4. The heat dissipation device as claimed in claim 3, wherein the two supporting frames are parallel to the fins of the fin unit.

5. The heat dissipation device as claimed in claim 1, wherein the fan moves along an outer circumference of the fin unit when the fastening member is moved from a first fixing position to a second fixing position.

6. The heat dissipation device as claimed in claim 1, wherein the fan holder comprises a holding frame located over the fin unit and two pivoting portions extending downwardly from two opposite sides of the holding frame and pivotally connected to the two supporting frames, respectively.

7. The heat dissipation device as claimed in claim 6, wherein the fan holder further comprises two pivoting screws each extending through a corresponding one of the pivoting portions of the fan holder and screwing into a corresponding supporting frame, and the pivoting portions pivot in respect to the pivoting screws when the fastening member is moved from a first fixing position to a second fixing position.

8. The heat dissipation device as claimed in claim 7, wherein a fixing hole is defined in each of the supporting frames for a corresponding pivoting screw screwing therein, and an arc-shaped guiding groove is defined in each of the supporting frames, a circle defining the arc-shaped guiding groove having a center at the fixing hole.

9. The heat dissipation device as claimed in claim 8, wherein the supporting frame defines a plurality of sawteeth protruding from two long sides of the guiding groove.

10. The heat dissipation device as claimed in claim 9, wherein the fastening member comprises a screw member extending through the guiding groove and the corresponding pivoting portion of the fan holder, and an engaging nut threadedly engaging on the screw member.

11. The heat dissipation device as claimed in claim 10, wherein the screw member comprises a head, a post extending from the head, and at least a baffle rib protruding outwardly from an outer circumference of the post.

12. The heat dissipation device as claimed in claim 11, wherein the supporting frame and the pivoting portion are sandwiched between the head of the screw member and the engaging nut.

13. The heat dissipation device as claimed in claim 12, wherein the baffle rib connects with the head and extends along an axis of the post.

14. The heat dissipation device as claimed in claim 12, wherein when the baffle rib is stuck between two neighboring sawteeth of the supporting frame, whereby the fan holder is fixed to the supporting frames and the fan secured on the fan holder is fixedly positioned relative to the fin unit.

15. The heat dissipation device as claimed in claim 14, wherein when a distance between the engaging nut and a distal end of the baffle rib is long enough to make the baffle rib separated from the sawteeth of the supporting frame, the fan holder with the fan is pivotable relative to the pivoting screws.

16. The heat dissipation device as claimed in claim 11 further comprising an elastic member compressed between the head of the fastening member and the corresponding supporting frame.

17. The heat dissipation device as claimed in claim 10, wherein the engaging nut is a wing nut.
